(19) United States
(12) Patent Application Publication
(10) Pub. No.: US 2024/0248618 A1
(43) Pub. Date: Jul. 25, 2024

(54) DRIVE THAT LIMITS MAXIMUM POWER CONSUMPTION

(71) Applicants: Kabushiki Kaisha Toshiba, Tokyo (JP); Toshiba Electronic Devices & Storage Corporation, Tokyo (JP)

(72) Inventors: Richard M. EHRLICH, Edina, MN (US); Eric R. DUNN, Cupertino, CA (US)

(21) Appl. No.: 18/158,329

(22) Filed: Jan. 23, 2023

(51) Int. Cl. G06F 3/06

(52) U.S. Cl. CPC G06F 3/0625; G06F 3/0659; G06F 3/0674

(57) ABSTRACT

A method for performing disk access operations in a disk drive includes: storing commands to perform disk access operations in a command queue for the disk drive; determining a first total cost for performing a first command stored in the command queue, wherein the first total cost is based on at least a first energy cost associated with starting execution of the first command; determining a second total cost for performing a second command stored in the command queue, wherein the second total cost is based on at least a second energy cost for the second command; and in response to determining that the first total cost is less than the second total cost, selecting the first command to be the next command stored in the command queue that is to be performed by the disk drive.

### BACKGROUND

Worldwide, data centers are estimated to consume between 200 and 400 terawatt hours of electrical energy annually, which is equivalent to approximately 1-2% of global electricity demand. A significant fraction of data center energy consumption is related to hard disk drives that provide the majority of data center storage. For example, some studies indicate that 11% or more of the total electricity used by data centers is for disk drives. Consequently, disk drives have been targeted as one element of data centers in which significant energy conservation can be realized.

In light of the above, there is a need in the art for disk drives that consume less power, particularly disk drives that are employed in data centers.

### SUMMARY

One or more embodiments provide systems and methods for limiting power consumption of a hard disk drive (HDD) during operation. According to the embodiments, a disk access command (referred to herein as a “command”) is selected to be performed from a command queue of the HDD based at least in part on an energy cost associated with performing the command. In some embodiments, a total cost is determined for commands in the command queue using a cost function, and the command having the lowest total cost is selected to be performed next by the HDD. Because the cost function is based at least in part on an energy cost associated with performing a given command, selection of commands to be performed from the command queue is biased toward commands that require less energy to be executed, such as commands that require lower accelerations and decelerations of the voice coil motor of the HDD. Consequently, the average power consumption of the HDD over time is reduced. In some embodiments, a weighting of energy cost in the cost function can vary relative to other factors included in the cost function, depending on a running average of power consumed by the HDD. In such embodiments, as the running average of power consumed by the HDD increases, energy cost associated with performing a given command becomes a more heavily weighted factor in the cost function, and higher energy commands are less likely to be selected.

According to an embodiment, a method for performing disk access operations in a disk drive includes: storing commands to perform disk access operations in a command queue for the disk drive; determining a first total cost for performing a first command stored in the command queue, wherein the first total cost is based on at least a first energy cost associated with starting execution of the first command; determining a second total cost for performing a second command stored in the command queue, wherein the second total cost is based on at least a second energy cost for the second command; and in response to determining that the first total cost is less than the second total cost, selecting the first command to be the next command stored in the command queue that is to be performed by the disk drive.

A disk drive, according to an embodiment, includes: a disk with one or more recording surfaces; and a controller. The controller is configured to perform the steps of: storing commands to perform disk access operations in a command queue for the disk drive; determining a first total cost for performing a first command stored in the command queue, wherein the first total cost is based on at least a first energy cost associated with starting execution of the first command; determining a second total cost for performing a second command stored in the command queue, wherein the second total cost is based on at least a second energy cost for the second command; and in response to determining that the first total cost is less than the second total cost, selecting the first command to be the next command stored in the command queue that is to be performed by the disk drive.

### BRIEF DESCRIPTION OF THE DRAWINGS

So that the manner in which the above recited features of embodiments can be understood in detail, a more particular description of embodiments, briefly summarized above, may be had by reference to the appended drawings. It is to be noted, however, that the appended drawings illustrate only typical embodiments and are therefore not to be considered limiting of its scope, for the invention may admit to other equally effective embodiments.

FIG. 1 is a schematic view of an exemplary hard disk drive, according to one embodiment.

FIG. 2 schematically illustrates a recording surface of a storage disk with concentric data storage tracks formed thereon, according to an embodiment.

FIG. 3 illustrates an operational diagram of the HDD of FIG. 1 configured to implement various embodiments.

FIG. 4 is a graph illustrating a weighting function 400 that is included in a cost function for selecting commands, according to various embodiments.

FIG. 5 sets forth a flowchart of method steps for scheduling execution of commands in a disk drive, according to various embodiments.

FIG. 6 sets forth a flowchart of method steps for scheduling execution of commands in a disk drive, according to various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

### System Overview

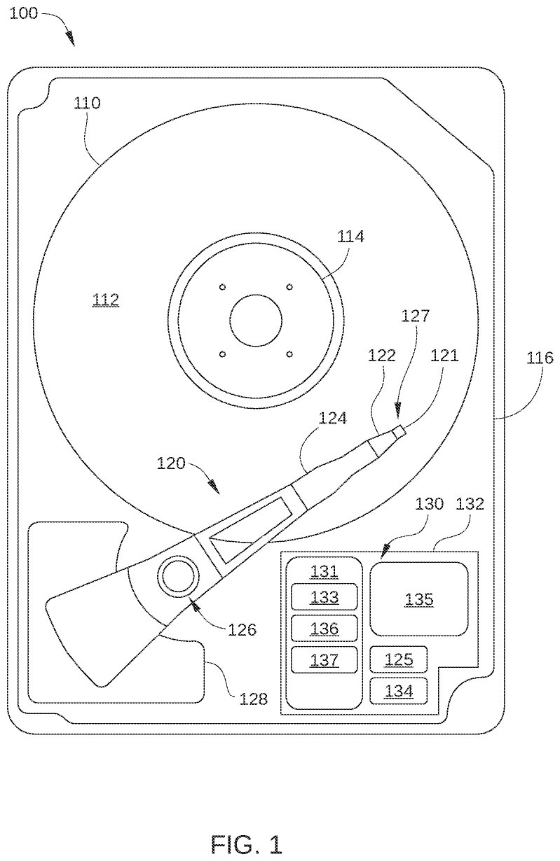

FIG. 1 is a schematic view of an exemplary hard disk drive (HDD) 100, according to one embodiment. For clarity, HDD 100 is illustrated without a top cover. HDD 100 includes multiple storage disks 110 (only one of which is visible in FIG. 1) that each include one or two recording surfaces 112 on which a plurality of concentric data storage tracks are disposed. Storage disks 110 are coupled to and rotated by a spindle motor 114 that is mounted on a base plate 116. An actuator arm assembly 120 is also mounted on base plate 116, and includes one or more sliders 121 (only one of which is visible in FIG. 1), each mounted on a flexure arm 122 with a magnetic read/write head 127 that reads data from and writes data to the data storage tracks of an associated recording surface 112. Each flexure arm 122 is attached to an actuator arm 124 that is rotated about a bearing assembly 126 by a voice coil motor (VCM) 128. Thus, VCM 128 moves all of the one or more sliders 121 radially relative to a respective recording surface 112 of a respective storage disk 110, thereby positioning a read/write head 127 over a desired concentric data storage track.

Spindle motor 114, read/write head 127, and VCM 128 are coupled to electronic circuits 130, which are mounted on a printed circuit board 132. In some embodiments, each read/write head 127 has an associated additional actuator, such as a microactuator. The additional actuator (not shown in FIG. 1) could be on the suspension (i.e., flexure arm 122), at the gimbal between the suspension and slider 121, or on slider 121, and can move the associated read/write head 127 radially a small distance. Such actuators are generally referred to as dual-stage actuators, and enable the servo system of HDD 100 to attain more accurate tracking control.

In the embodiment illustrated in FIG. 1, a single actuator arm assembly 120 is shown that includes only one slider 121, one flexure arm 122, one actuator arm 124, and one read/write head 127. In other embodiments, actuator arm assembly 120 includes a plurality of actuator arms 124, sliders 121, flexure arms 122, and read/write heads 127, where each read/write head 127 is associated with a different recording surface 112 of HDD 100. Further, in some embodiments, HDD 100 can include multiple actuator arm assemblies 120 that are each rotated about bearing assembly 126 by a respective VCM 128 independently from each other. In such embodiments, each actuator arm assembly 120 may each include a plurality of actuator arms 123, sliders 121, flexure arms 122, and read/write heads 127.

Electronic circuits 130 include a read/write channel 137, a microprocessor-based controller 133, random-access memory (RAM) 134 (which may be a dynamic RAM and used as one or more data buffers) and/or a flash memory device 135, and, in some embodiments, a flash manager device 136. In some embodiments, read/write channel 137 and microprocessor-based controller 133 are included in a single chip, such as a system-on-chip 131. In some embodiments, HDD 100 further includes a motor-driver chip 125 that accepts commands from microprocessor-based controller 133 and drives both spindle motor 114 and VCM 128. Read/write channel 137 communicates with the read/write head 127 via a preamplifier (not shown) that may be mounted on a flex-cable that is itself mounted on either base plate 116, actuator arm 120, or both.

When data are transferred to or from a particular storage disk 110 of HDD 100, actuator arm assembly 120 moves in an arc between the inner diameter (ID) and the outer diameter (OD) of a particular storage disk 110. Actuator arm assembly 120 accelerates in one angular direction when current is passed in one direction through the voice coil of VCM 128 and accelerates in an opposite direction when such current is reversed, thereby allowing control of the position of actuator arm assembly 120 and the attached read/write head 127 with respect to the particular storage disk 110. VCM 128 is coupled with a servo system that uses the positioning data read from servo wedges on storage disk 110 by read/write head 127 to determine the position of read/write head 127 over a specific data storage track. For example, the servo system may position read/write head 127 over recording surface 112 based on positioning data read from recording surface 112.

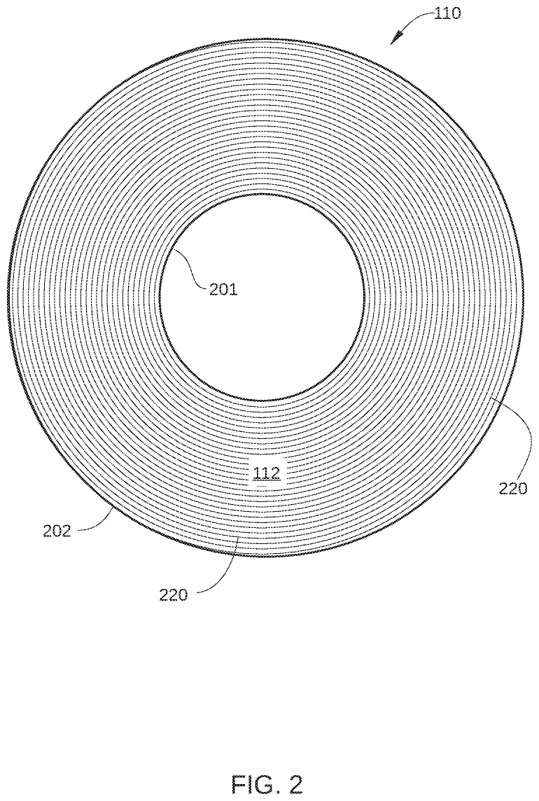

In positioning a read/write head 127 over a recording surface 112, the servo system determines an appropriate current to drive through the voice coil of VCM 128, and drives said current using a current driver and associated circuitry. Typically, the appropriate current is determined based in part on a position feedback signal of the read/write head 127, such as a position error signal (PES). The PES is typically generated by using servo patterns included in the servo wedges (not shown) on the recording surface 112 as a reference. One embodiment of a recording surface 112 is illustrated in FIG. 2.

FIG. 2 schematically illustrates a recording surface 112 of a storage disk 110 with concentric data storage tracks 220 formed thereon, according to an embodiment. Data storage tracks 220 are formed on recording surface 112 between an ID 201 and an OD 202 of storage disk 110. Data storage tracks 220 are configured for storing data, and the radial position and track pitch, i.e., spacing, of data storage tracks 220 is defined by servo sectors (not shown) formed on recording surface 112. Each servo sector contains a reference signal that is read by read/write head 127 during read and write operations to position read/write head 127 above a desired data storage track 220. Typically, the actual number of data storage tracks 220 included on recording surface 112 is considerably larger than illustrated in FIG. 2. For example, recording surface 112 may include hundreds of thousands of concentric data storage tracks 220.

### Command Scheduling Based on Command Energy Cost and Drive Energy Consumption

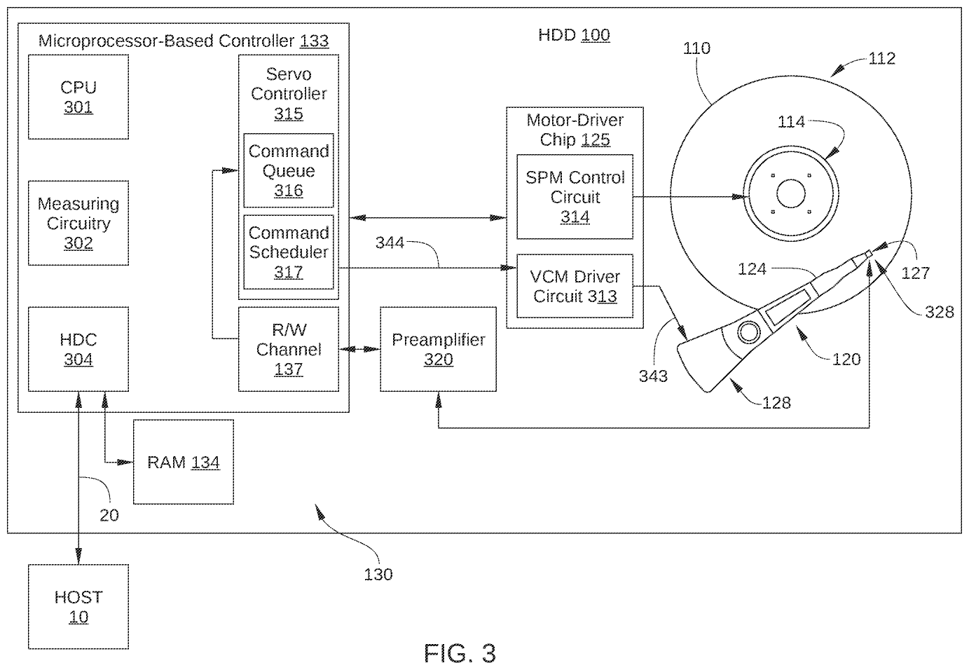

In operation, HDD 100 of FIG. 1 typically receives a plurality of disk access commands to be performed, for example from a host, and stores the disk access commands in a command queue. Such disk access commands (referred to herein as a “commands”) include input/output operations, such as read operations and write operations. Oftentimes, particularly in server and data center HDDs, a large number of such commands can accumulate in the command queue while a previously received command is being executed. For example, certain ATA (advanced technology attachment) and small computer system interface (SCSI) HDDs may operate with a native command queuing (NCQ) or tagged command queuing (TCQ) protocol that allows a host or operating system to send multiple read and/or write requests to the HDD. To increase performance and reduce drive wear in such situations, HDDs can be configured with a disk scheduling algorithm that optimizes the order in which received read and write commands are executed, such that the amount of head movement is reduced. For example, some HDDs operate with a so-called elevator algorithm, in which queued commands are executed only in the current direction of actuator arm movement, until the arm reaches the edge of the storage disk and the direction of the actuator arm reverses. Alternatively, some HDDs operate with a so-called nearest neighbor algorithm, in which the queued command that is executed is the one for which the associated R/W operation can begin the soonest. Alternatively, according to various embodiments, a command scheduler determines a command from a command queue based at least in part on an energy cost associated with beginning execution of a command. One such embodiment is illustrated in FIG. 3.

FIG. 3 illustrates an operational diagram of HDD 100 configured to implement various embodiments. In the embodiment illustrated in FIG. 3, a specific configuration of certain elements of electronic circuits 130 is described. In other embodiments, any other suitable arrangement or configuration of electronic circuits 130 may be employed that is operable to implement one or more embodiments described herein. For example, in some embodiments, various elements of microprocessor-based controller 133 may be configured in a single SoC and/or implemented as stand-alone chips included in electronic circuits 130.

HDD 100 is connected to a host 10, such as a host computer, via a host interface 20, such as a serial advanced technology attachment (SATA) bus or a Serial Attached Small Computer System Interface (SAS) bus. As shown, electronic circuits 130 of HDD 100 include microprocessor-based controller 133 and motor driver chip 125 communicatively coupled to microprocessor-based controller 133.

In the embodiment illustrated in FIG. 3, microprocessor-based controller 133 includes one or more central processing units (CPUs) 301 or other processors, measuring circuitry 302, a servo controller 315, a hard disk controller (HDC) 304, and read/write channel 137. Motor-driver chip 125 includes a VCM driver circuit 313 and a spindle motor (SPM) control circuit 314. VCM driver circuit 313 generates an amplified control signal 343 in response to control signals 344 (such as VCM commands) output from servo controller 315. Control signals 344 and amplified control signals 343 enable execution of disk access commands received from host 10 that are to be executed by a servo system of HDD 100 that includes VCM 128. Motor-driver chip 125 may also contain microactuator driver circuitry (not shown), which can drive microactuators, as described earlier.

In the embodiment illustrated in FIG. 3, HDD 100 includes a single RAM 134 that is external to microprocessor-based controller 133. In other embodiments, HDD 100 may include any other suitable configuration of RAM 134, such as a DRAM device integrated in microprocessor-based controller 133.

HDD 100 further includes a preamplifier 320 associated with read/write head 127. Preamplifier 320 can be mounted on actuator arm assembly 120 or elsewhere within the head and disk assembly (HDA) of HDD 100. Preamplifier 320 amplifies a read signal output from a read sensor of read/write head 127 and transmits the amplified read signal to read/write channel 137. In addition, preamplifier 320 supplies a write signal (e.g., current) to a write head of read/write head 127 in response to write data input from read/write channel 137.

CPU 301 controls HDD 100, for example according to firmware stored in flash memory device 135 (shown in FIG. 1) or another nonvolatile memory, such as portions of recording surfaces 112. For example, CPU 301 manages various processes performed by HDC 304, read/write channel 137, recording surfaces 112, and/or motor-driver chip 125. Such processes include a writing process for writing data onto recording surfaces 112, a reading process for reading data from recording surfaces 112, various calibration processes, a self-servo-writing process, and the like.

Read/write channel 137 is a signal processing circuit that decodes read signals transmitted from preamplifier 320 into read data that are outputted to HDC 304. In addition, read/write channel 137 encodes write data input from HDC 304 and outputs the encoded write data to preamplifier 320. In some embodiments, HDC 304 controls access to RAM 134 by CPU 301 and read/write channel 137, and receives/transmits data from/to host 10. In some embodiments, HDC 304 receives/transmits data from/to host 10 via interface 20.

In some embodiments, a servo system of HDD 100 (e.g., CPU 301, read/write channel 137, preamplifier 320, servo controller 315, voice-coil motor 128, and a suitable microactuator 328) performs positioning of read/write head 127 included in actuator arm assembly 120 over a corresponding recording surface 112, during which servo controller 315 determines an appropriate current to drive through the voice coil of VCM 128. Typically, the appropriate current is determined based in part on a position feedback signal of read/write head 127, such as PES. To begin execution of a command, such as a read operation or a write operation, the servo system of HDD 100 seeks read/write head 127 to the appropriate data storage track on recording surface 112. For longer seeks, larger accelerations, and therefore larger current draws, are generally employed to minimize latency in execution of the associated command. Thus, a command that requires a longer seek across recording surface 112 generally uses more power to position read/write head 127 than a command that requires a shorter seek.

Servo controller 315 receives positioning information from read/write channel 137 and determines a PES for read/write head 127 based on the received positioning information and a target position of read/write head 127. Servo controller 315 then generates control signals 344 based on the PES. According to various embodiments, servo controller 315 includes a command queue 316 and a command scheduler 317.

Command queue 316 stores commands, such as commands for read operations and write operations, that have been received from, for example, host 10. In some embodiments, command queue 316 is configured to store on the order of about 32 commands, such as embodiments in which command queue 316 is implemented with static RAM (SRAM). Alternatively, in some embodiments, command queue 316 is configured to store hundreds or thousands of commands received from host 10. In such embodiments, command queue 316 can be implemented in a portion of RAM 134 and/or some other RAM device included in electronic circuits 130. In operation, while HDD 100 executes a particular command selected from command queue 316 and then removes that executed command from command queue 316, more commands are typically added to command queue 316. Thus, in many instances, command queue 316 is not cleared for significant time intervals, particularly in an HDD employed in a server and/or data center application. In the embodiment illustrated in FIG. 3, command queue 316 is depicted as a component of servo controller 315. In other embodiments, command queue 316 is operationally associated with servo controller 315, but can be implemented as a separate hardware element included in electronic circuits 130, such as a portion of RAM 134, a dedicated RAM device (not shown) included in microprocessor-based controller 133, and the like. In other embodiments, command queue 316 can be managed by CPU 301, or one or more of multiple CPUs 301.

Command scheduler 317 schedules execution of the commands stored in command queue 316. Therefore, while HDD 100 executes one command selected from command queue 316, command scheduler 317 determines the next command to be performed from the commands stored in command queue 316. According to various embodiments, command scheduler 317 determines the next command to be performed based at least in part on the energy cost associated with performing some or all of the commands stored in command queue 316. For example, in some embodiments, command scheduler 317 determines the next command to be performed using a cost function that includes as a factor an energy cost for each command stored in command queue 316. In some embodiments, the energy cost for a particular command includes an energy associated with starting execution of that particular command. In such embodiments, the energy cost of the particular command can be determined based at least in part on the electrical current that is needed to seek read/write head 127 to a specific data storage track associated with starting execution of the command. Thus, in such embodiments, a command that has a relatively high energy cost associated with starting execution (such as a command that can only be initiated with a relatively long seek, or a seek of moderate length that must be completed very quickly) is less likely to be selected from command queue 316 than a command that has a relatively low energy cost associated with starting execution (such as a command that can be initiated with a relatively short seek, or a seek of moderate length that does not need to be completed very quickly). Alternatively or additionally, in some embodiments, the energy cost for a particular command includes an energy for executing a read or write operation associated with that particular command. In such embodiments, the energy cost of the command can be determined based at least in part on an electrical power that is calculated to be needed to read data from sectors indicated in the command or write specified data to sectors indicated in the command. Thus, in such embodiments, a first command that includes the reading and concomitant error-correction coding operations of a long sequence of adjacent sectors generally has a higher energy cost than a second command that includes writing data to a small number of sectors. Therefore, in such embodiments, the second command is more likely to be selected from command queue 316 than the first command. Alternatively or additionally, in some embodiments, the energy cost for a particular command includes the above-described energy associated with starting execution of that particular command and the above-described energy for executing a read or write operation associated with that particular command.

In some embodiments, the energy cost associated with starting execution of a particular command in command queue 316 indicates energy that would be consumed by starting execution of that particular command, i.e. seeking read/write head 127 to a starting data track of that particular command. In some embodiments, the energy cost for the command is computed based on an electrical current (or power) associated with starting execution of the command and on a time associated with execution of the command. For example, in some embodiments, the energy cost for the command is computed based on the electrical current associated with starting execution of the command multiplied by the time associated with starting execution of the command. In such embodiments, the current associated with execution of the command is the current needed by VCM 128 for seeking read/write head 127 to a radial location on recording surface 112 so that execution of the command can start, and the time associated with execution of the command is the time interval over which the seek to the radial location will occur.

It is noted that the current applied to VCM 128 during a seek is generally not a constant value, due to non-constant radial acceleration of read/write head 127 during the seek, non-constant radial deceleration of read/write head 127 during the seek, and zero-acceleration (coasting) intervals that may occur within the seek. Therefore, in some embodiments, determination of the energy cost for a particular command in command queue 316 is more complex than multiplication of a single electrical current value by a single time value. For example, in some embodiments, the energy cost for a particular disk access command is determined on a control interval basis. Thus, in such embodiments, the energy cost for a particular disk access command is determined by calculating energy for each VCM command (e.g., a VCM electrical current value applied to VCM 128 for a single control interval) that would be utilized during the seek required to initiate the particular disk access command (e.g., a read operation or a write operation). In such embodiments, the energy cost for the particular disk access command is the sum of the calculated energy for each of the VCM commands that would occur during the required seek. In such embodiments, the energy for each VCM command that would be utilized may be based on the VCM electrical current value and a voltage value for the VCM command. In such embodiments, the energy for each VCM command that would be utilized may be further based on a time value associated with the VCM command, such as a duration of a time interval (e.g., a control interval associated with the VCM command) in which the VCM electrical current value is applied to VCM 128. In other embodiments, the energy for each VCM command that would be utilized may be based on the square of the VCM electrical current and the VCM coil resistance (also known as “i²R dissipation”). Such a method for determining the energy cost of a seek ignores effects of back-EMF. For some embodiments, this method may provide a more accurate determination of the energy cost of a seek, since a properly-configured switching amplifier can recover energy from the VCM during the deceleration phase of a seek.

Alternatively, in some embodiments the energy cost for the particular disk access command can be an estimated energy cost that is based at least in part on a seek length. In such embodiments, the seek length is the radial displacement required to position read/write head 127 at a starting radial location on recording surface 112 for the particular disk access command. In such embodiments, the energy cost for a particular disk access command can be determined via a lookup table based on such a seek length. In some embodiments, the seek length is a radial distance, for example measured in data tracks, between an ending radial location (e.g., an ending track number) of a disk access command currently being performed and a starting radial location (e.g., a starting track number) of the particular disk access command. In such embodiments, when no disk access command is currently being performed, the seek length is a radial distance between the current radial location of read/write head 127 and the starting radial location of the particular disk access command. In some embodiments, HDD 100 supports multiple seek modes (for example, high-speed, moderate-speed, or low-speed). In such embodiments, the energy cost of a seek can be determined via a number of lookup tables, depending upon the chosen seek mode. Thus, in such embodiments, multiple energy costs can be associated with a single seek length.

Additionally, in some embodiments, command scheduler 317 determines the next command to be performed further based on one or more other factors associated with some or all of the commands stored in command queue 316. For example, in some embodiments, the above-described cost function is a multi-factor cost function that is based on an average power recently consumed by HDD 100 (average consumed power P̅), a command priority associated with each command and/or a starting-time for each command (i.e., the time required to complete a seek and wait for the associated read or write data to pass under the R/W head) or a total time required to complete each command. Average consumed power P̅ and command priority are described in greater detail below. In such embodiments, command scheduler 317 determines the next command to be performed based on a total cost that is computed for commands stored in command queue 316 using the multi-factor cost function.

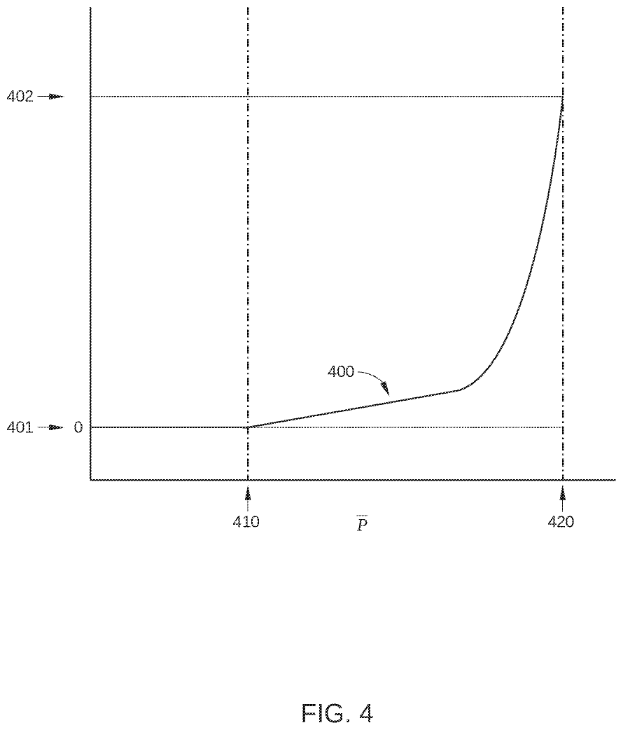

As noted above, in some embodiments, a cost function used by command scheduler 317 for determining the next command to be performed can be further based on an average consumed power P̅, where average consumed power P̅ can be a running average of power recently consumed by HDD 100. In such embodiments, a weighting in the cost function of the energy cost associated with performing a specific command stored in command queue 316 may not be constant. Instead, in some embodiments, the weighting of the energy cost associated with performing a specific command stored in command queue 316 varies as a function of the average consumed power P̅. In such embodiments, as average consumed power P̅ increases, for example due to more high-energy-cost commands being performed, the weighting of the energy cost associated with performing a specific command stored in command queue 316 also increases. Alternatively, in such embodiments, as average consumed power P̅ approaches a threshold value, such as a target maximum value for average consumed power P̅, the weighting of the energy cost associated with performing a specific command stored in command queue 316 also increases. In either case, as average consumed power P̅ increases, the weighting of energy cost associated with each command becomes more important in the cost function, and command scheduler 317 is biased to select commands stored in command queue 316 that have a lower energy cost. In some embodiments such a weighting of energy cost is implemented as a function of average consumed power P̅. One such embodiment is described below in conjunction with FIG. 4.

FIG. 4 is a graph illustrating a weighting function 400 that is included in a cost function for selecting commands, according to various embodiments. A current value of weighting function 400 is employed in a cost function for determining a total cost for a particular command to be executed by HDD 100. For example, the current value of weighting function 400 can operate as a coefficient that modifies the contribution of an energy cost computed for the particular command to the total cost for that particular command. Thus, as the value of weighting function 400 increases, the contribution of the energy cost computed for a particular command to the total cost for the particular command also increases. As a result, a command with a specific energy cost can have a different total cost associated therewith depending on the value of average consumed power P̅ when the total cost is computed for the command.

Values of weighting function 400 vary from a minimum value 401 to a maximum value 402, based on the current value of average consumed power P̅. In the embodiment shown in FIG. 4, weighting function 400 increases non-linearly as the value of average consumed power P̅ approaches an upper threshold value 420. Consequently, as average consumed power P̅ approaches upper threshold value 420, the value of weighting function 400 increases along a highly non-linear trajectory. Therefore, as average consumed power P̅ approaches upper threshold value 420, the energy cost for a particular command is multiplied by a larger value, and the contribution of the energy cost for that particular command to the total cost for the particular command increases proportionately.

In some embodiments, maximum value 402 of weighting function 400 is selected to prevent a command with a higher energy cost from being selected as the value of average consumed power P̅ approaches upper threshold value 420. For example, in such embodiments, maximum value 402 can be selected so that the contribution of the energy cost of such a command exceeds the total cost of other commands stored in command queue 316 that have a high contribution to total cost from other factors, such as a command priority, a starting-time, and/or a total time required for completion associated with the commands.

In some embodiments, minimum value 401 of weighting function 400 equals zero. In such embodiments, minimum value 401 causes an energy cost associated with a command to have no contribution to the total cost of that command. For example, in some embodiments, when the value of average consumed power P̅ is less than or equal to a lower threshold value 410, minimum value 401 equals 0. Thus, in such embodiments, in instances in which average consumed power P̅ is low, the total cost of commands is based on other factors and not on the energy cost associated with each of the commands. In other embodiments, minimum value 401 of weighting function 400 below lower threshold value 410 may be a low, non-zero value.

Returning to FIG. 3, in some embodiments, average consumed power P̅ is calculated based on a total power consumed by HDD 100. In such embodiments, average consumed power P̅ may include power consumed by VCM 128, read/write channel 137, motor-driver chip 125, preamplifier 320, and microprocessor-based controller 133. Alternatively, in some embodiments, average consumed power P̅ is calculated based on power consumed by specific elements of HDD 100. In such embodiments, average consumed power P̅ corresponds to the power consumed by elements of HDD 100 that vary significantly in power consumption during execution of different commands. For example, in one such embodiment, average consumed power P̅ corresponds to average power consumed by VCM 128. In such embodiments, the value of average consumed power P̅ is affected by the accelerations and decelerations of VCM 128 associated with seeking read/write head 127 in the performance of recent commands. In another such embodiment, average consumed power P̅ corresponds to average power consumed by VCM 128 and read/write channel 137. In such embodiments, the value of average consumed power P̅ is affected by the total power consumption associated with the performance of recent commands, including energy expended to perform seeks and energy expended to execute read or write operations. In yet another such embodiment, average consumed power P̅ corresponds to average power consumed by VCM 128, read/write channel 137, and preamplifier 320.

In some embodiments, average consumed power P̅ is calculated based on a specific time interval (referred to herein as an averaging time interval) during which power is consumed by HDD 100 or certain elements of HDD 100. That is, average consumed power P̅ is determined by averaging power consumed in execution of the commands that are executed over the averaging time interval. For example, in one such embodiment, the averaging time interval is the most recent 30 seconds, 1 minute, 2 minutes, 3 minutes, or the like. In some embodiments, average consumed power P̅ can be calculated as a weighted average of a plurality of consumed power values. For example, in some embodiments, consumed power at different times during the averaging time interval can be exponentially averaged, so that a greater weight and significance is placed on the consumed power associated with the most recently executed commands of the averaging time interval, compared to consumed power associated with commands executed at the beginning of the averaging time interval. Multiple embodiments for using exponential averaging to determine average consumed power P̅ are described below.

In some embodiments, average consumed power P̅ is approximated for the averaging time interval (e.g., the most recent 30 seconds, 1 minute, etc.) by dividing the averaging time interval into K equal subintervals and exponentially averaging the consumed power that is determined for each of the K subintervals. In such embodiments, each subinterval can be a control interval associated with a specific VCM command, where each disk access command that occurs within the averaging time interval includes a plurality of such subintervals. For example, in an embodiment in which a servo sample rate is on the order of about 50 kHz and two VCM commands are output for each servo sampling, and the averaging time interval is 1 second, K=100,000, and each subinterval is on the order of about 1/100,000 of a second, or 10 microseconds. In such an embodiment, the exponential averaging of the consumed power for each of the K subintervals can be considered a low-pass filtering (smoothing) operation that is performed on the K subintervals. Assuming the averaging time interval is 30 seconds and can be considered the characteristic time of the filtering operation, the characteristic time constant & is 1/(100,000×30)=1/3,000,000. In some embodiments, the exponentially-averaged consumed power P̅ₖ by HDD 100 for the most recent K subintervals can be determined using Equation 1:

$${\overline{P}}_{k} = [ 1 - ε ] {\overline{P}}_{k - 1} + ε {AP}_{k} \qquad ( 1 )$$

where P̅ₖ₋₁ is the previously determined exponentially-averaged consumed power by HDD 100 and APₖ is a consumed power value for the kth subinterval. In some embodiments, exponentially-averaged consumed power P̅ₖ is determined as a running average by updating the value of exponentially-averaged consumed power P̅ₖ at each subinterval. In such embodiments, the many thousands of mathematical operations and stored previous values of exponentially-averaged consumed power P̅ₖ are not required to determine exponentially-averaged consumed power P̅ₖ, even though each of the k previous values contribute to exponentially-averaged consumed power P̅ₖ in Equation 1 for the current subinterval.

In some embodiments, average consumed power P̅ is determined based on an average consumed power for each of the N disk access commands (e.g., read or write operations) that is performed during the averaging time interval. In such embodiments, the time extent of each command is included in the determination of average consumed power P̅. In such embodiments, average consumed power P̅ is calculated by averaging the power consumed by HDD 100 (or certain elements of HDD 100) during the specific time interval, where the consumed power is associated with the N most recently executed commands. In such embodiments, an average consumed power P̅ₙ can be determined for the N commands associated with the averaging time interval via Equation 2:

$${\overline{P}}_{n} = [ 1 - ε Δ {T}_{n} ] {\overline{P}}_{n - 1} + ε Δ {T}_{n} {P}_{n} \qquad ( 2 )$$

wherein an average consumed power value Pₙ is the average power consumed by HDD 100 during the nth command and ΔTₙ is the amount of time that the nth command takes to complete. In Equation 2, ΔTₙ accounts for the different amounts of time that each of the N commands takes to complete.

As noted previously, in some embodiments, command scheduler 317 determines the next command to be performed from the commands stored in command queue 316 based on a total cost for some or all of the stored commands. In such embodiments, the total cost for a particular command is further based on consumed power value Pₙ for that command. As a result, in such embodiments, a command that has an estimated consumed power value Pₙ that causes average consumed power P̅ to exceed a threshold value (such as upper threshold value 410 in FIG. 4) results in a very high total cost being determined for that command.

In some embodiments, each consumed power value Pₙ for a particular disk access command (or consumed power value APₖ for a particular subinterval) is determined based at least in part on a plurality of measured VCM electrical current values and/or measured voltage values associated with that particular disk access command. In such embodiments, measuring circuitry 302 directly measures VCM current applied to VCM 128 and/or the voltage applied to VCM 128 during execution of the particular disk access command. Thus, in such embodiments, measuring circuitry 302 directly measures VCM current applied to VCM 128 and/or the voltage applied to VCM 128 during the plurality of VCM commands (e.g., VCM electrical current values that are applied to VCM 128) included in the particular disk access command. Alternatively, in some embodiments, each consumed power value Pₙ for a particular disk access command (or consumed power value APₖ for a particular subinterval) is determined based on estimated VCM current values and/or estimated voltages and/or an estimated VCM resistance. In such embodiments, the estimated VCM current values for determining consumed power value Pₙ for the particular disk access command (or consumed power value APₖ) are based on the plurality of VCM commands associated with that particular disk access command, and the estimated voltages are based on a nominal voltage that is applied to VCM 128. Typically, the VCM resistance can vary significantly with temperature. In some embodiments, the VCM resistance may be estimated using a table-lookup, based upon a measured VCM coil temperature. Alternatively, in some embodiments, the VCM resistance can be estimated via observation of recent VCM commands and a measured acceleration of read/write head 127, as would be known by one of ordinary skill in the art.

In some embodiments, each consumed average power value Pₙ for a particular disk access command is determined based at least in part on an energy for executing a read or write operation associated with that particular command. In some embodiments, the energy for executing the read or write operation can be determined via parametric monitoring by read/write channel 137, which can indicate power consumed by read/write channel 137 for the particular disk access command. Alternatively, in some embodiments, the energy for executing the read or write operation can be estimated based on quantity of data (read or written) associated with that particular disk access command. Similarly, in some embodiments, each consumed power value APₖ for a particular subinterval is determined based at least in part on an energy for executing a read or write operation that includes that particular subinterval.

In some embodiments, HDD 100 is configured to recover energy from an actuator, such as VCM 128, when the actuator decelerates. That is, HDD 100 is configured so that energy is returned to a power source of HDD 100 during seek deceleration. In such embodiments, consumed average power value Pₙ for one or more disk access commands can be modified (e.g., reduced) based on the recovered energy that is returned to the power source of HDD 100 during the disk access commands. In some embodiments, the quantity of recovered energy can be determined based on various known parameters associated with the actuator, such as coil resistance, coil inductances, estimated back electromotive force (EMF), and the like.

As noted above, in some embodiments, a cost function used by command scheduler 317 for determining the next command to be performed can be further based on a command priority. In such embodiments, each command stored in command queue 316 can have a priority associated therewith. In some embodiments, the priority associated with a particular command can be a high-priority bit that indicates whether that particular command is a high-priority command or is not a high-priority command. In some embodiments, the priority associated with a particular command can be priority value that indicates a more granular state of the priority of commands stored in command queue 316, such as “high priority,” “medium priority,” or “low priority.” Alternatively or additionally, in some embodiments, the priority associated with a particular command can be a priority value indicating a position on a numerical priority scale. In some embodiments, the priority associated with a particular command can be a time associated with that particular command, such as a time at which that particular command is initially stored in command queue 316 or a required time at which that particular command must be executed. In some embodiments, a priority value for a particular command is received by HDD 100 with the command. In other embodiments, the priority value is computed by command scheduler 317 or some other logic included in HDD 100.

As noted above, in some embodiments, a cost function used by command scheduler 317 for determining the next command to be performed can be further based on a time to start a read/write operation for each command or a total time required to complete each command. In such embodiments, a total cost of a particular command is increased as a function of the time required to begin that particular command upon completion of the command that is currently underway. Thus, in such embodiments the total cost of the particular command is increased as a function of the seek time plus the rotational latency computed for that particular command. Alternatively, in some embodiments, a total cost of a particular command is increased as a function of the time required to complete execution of that particular command once the command that is currently underway is completed. Thus, in such embodiments, a command that is associated with a long sequential read or write operation generally has a larger total cost than a command that is associated with a short read or write operation.

In the embodiment illustrated in FIG. 3, various links are shown between certain elements of HDD 100 for enablement of certain embodiments. In some embodiments, additional and/or alternative links between certain elements of HDD 100 may exist for operation of HDD 100, but are not shown for clarity and ease of description. Such additional and/or alternative links would be known to one of ordinary skill in the art.

### First Embodiment of Command Scheduling Process

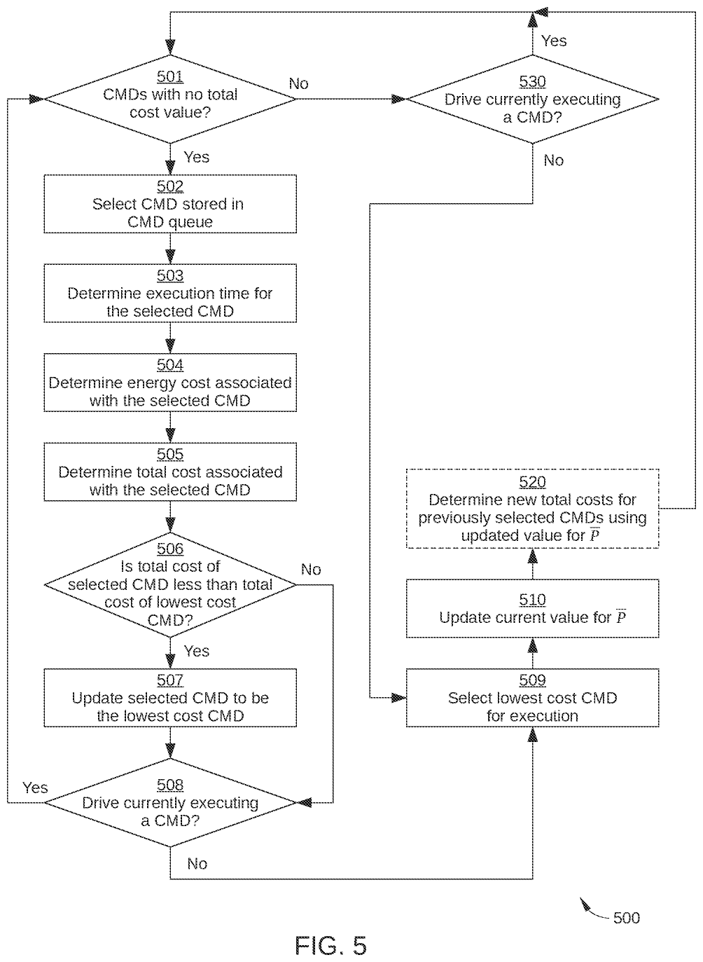

FIG. 5 sets forth a flowchart of method steps for scheduling execution of commands in a disk drive, according to various embodiments. The method steps may include one or more operations, functions, or actions as illustrated by one or more of blocks 501-530. Although the blocks are illustrated in a sequential order, these blocks may be performed in parallel, and/or in a different order than described herein. Also, the various blocks may be combined into fewer blocks, divided into additional blocks, and/or eliminated based upon a specific implementation. Although the method steps are described in conjunction with HDD 100 of FIGS. 1-3, persons skilled in the art will understand that the method steps may be performed with other types of systems. The control algorithms for the method steps may reside in microprocessor-based controller 133, some other controller associated with HDD 100, servo controller 315, command scheduler 317, or a combination thereof. The control algorithms can be implemented in whole or in part as software- or firmware-implemented logic, and/or as hardware-implemented logic circuits.

Prior to the method steps, HDD 100 begins operation, receives one or more commands, and stores the one or more commands in command queue 316. Generally, this process continues simultaneously with method 500. Thus, a method 500 is typically performed while HDD 100 is receiving commands and storing them in command queue 316.

Method 500 begins at step 501, when a suitable controller (e.g., microprocessor-based controller 133, servo controller 315, and/or command scheduler 317) determines whether there are one or more commands stored in command queue 316 for which no total cost has been computed. If no, method 500 proceeds to step 530; if yes, method 500 proceeds to step 502. In step 502, the controller selects a command from command queue 316 for which no total cost has been determined.

In step 503, the controller determines an execution time for the selected command. In some embodiments, the execution time is an estimated time required for the selected command to begin to be executed and is calculated based on a seek length associated with the selected command. For example, in some embodiments, the seek length is a radial displacement of read/write head 127 that is required to position read/write head 127 at a radial location on recording surface 112 so that execution of the selected command can begin. In some embodiments, the execution time for the selected command is a weighted factor included in the cost function for determining a total cost for the selected command.

In step 504, the controller determines an energy cost associated with the selected command. In some embodiments, the energy cost for a particular command corresponds to energy consumed so that the particular command can begin execution. Therefore, in such embodiments, the energy cost for a particular command corresponds to energy consumed during a seek that positions read/write head 127 so that the particular command can begin. In other embodiments, the energy cost for a particular command corresponds to the energy consumed when the particular command is executed, which includes energy consumed by read/write channel 137. In some embodiments, the energy cost for the selected command is a weighted factor included in the cost function for determining a total cost for the selected command.

In step 505, the controller determines a total cost for the selected command, for example via a cost function that can include multiple factors. As described above, the cost function can generate a total cost for a particular command stored in command queue 316 based on the energy cost of the particular command, an average consumed power P̅ of HDD 100, a starting-time for the particular command, a total time required to complete the particular command, and/or a command priority of the particular command. In some embodiments, the average consumed power P̅ includes an estimated consumed power value Pₙ for the selected command. In some embodiments, the weighting of the energy cost of the selected command in the cost function can vary based on the current value of average consumed power P̅. Further, in some embodiments, a command priority can include a priority value that causes the cost function to prioritize the selected command over some or all other selected commands for which a total cost has been determined. Thus, in such embodiments, when the selected command has such a priority value associated therewith, the selected command has a very small total cost.

In step 506, the controller determines whether the total cost of the selected command is less than the total cost of a lowest cost command currently stored in command queue 316. If no, method 500 proceeds to step 508; if yes, method 500 proceeds to step 507. In step 507, the controller updates the selected command to be the lowest cost command.

In step 508, the controller determines whether HDD 100 is currently executing a command from command queue 316. If yes, method 500 returns to step 501; if no, method 500 proceeds to step 509.

In step 509, the controller selects for execution the lowest cost command currently stored command queue 316. The controller may then begin seeking read/write head 127 to the appropriate radial location on storage disk 110 so that execution of the lowest cost command can begin. In step 510, the controller updates the current value of average consumed power P̅ to include the lowest cost command.

In step 520, the controller determines new total costs for previously selected commands for which a total cost has been determined. In the embodiment illustrated in FIG. 5, in step 520, the updated value of average consumed power P̅ is employed when determining the new total costs for the previously selected commands. Method 500 then proceeds to step 501.

In step 530, the controller determines whether HDD 100 is currently executing a command from command queue 316. If yes, method 500 returns to step 501; if no, method 500 proceeds to step 509.

In method 500, energy cost of a command is considered before being selected for execution, and therefore implementation of method 500 enables the energy consumption of HDD 100 to be reduced without significantly affecting performance. In addition, other factors can be considered in selecting commands. Therefore, in some instances, high-priority commands can still be executed even when a higher energy cost is associated therewith. Further, because the weighting of command energy cost can be varied as a function of average consumed power P̅, as average power consumption of HDD 100 increases, energy cost associated with performing a particular command becomes a more heavily weighted factor in the cost function, and higher energy commands are less likely to be selected. As a result, average consumed power P̅ can be maintained below a target threshold value.

### Second Embodiment of Command Scheduling Process

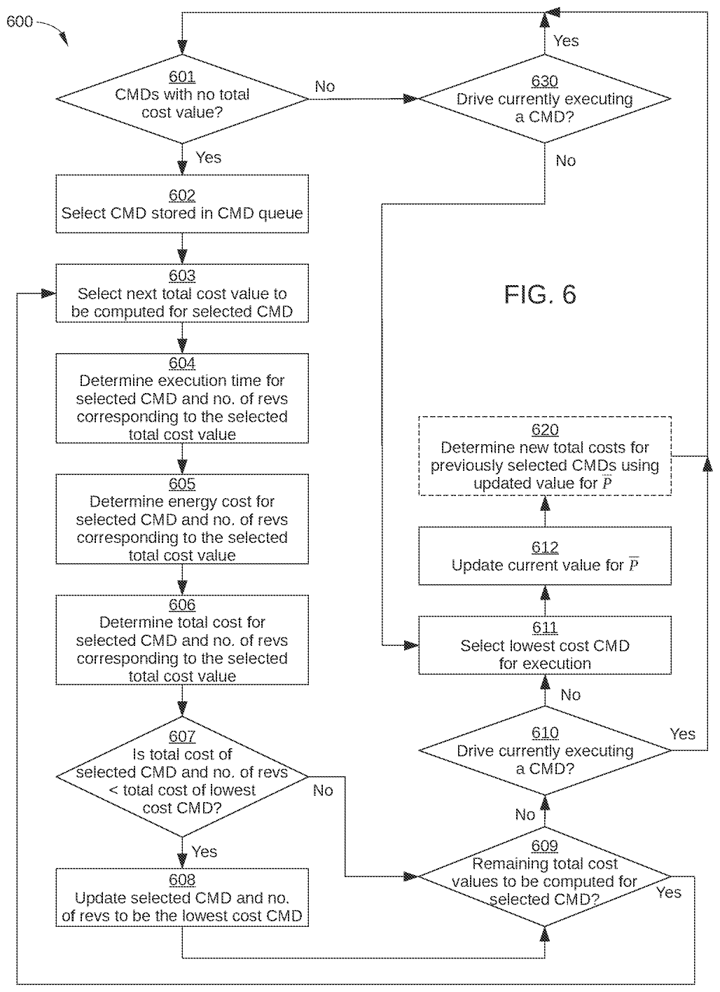

In some embodiments, when a command scheduler of an HDD schedules execution of the commands stored in command queue 316, multiple total costs are determined for each command. Specifically, for a given command, a first total cost is computed assuming that, if possible, the seek that is performed enables execution of the command to begin before a complete revolution of the storage disk has occurred. Then, for the same command, a second total cost is computed assuming that the seek that is performed enables execution of the command to begin after a complete revolution of the storage disk has occurred and before a second complete revolution of the storage disk has occurred. In some embodiments, for the same command, a third total cost is computed assuming that the seek that is performed enables execution of the command to begin after two complete revolutions of the storage disk have occurred and before a third complete revolution of the storage disk has occurred. In some embodiments, additional total costs are computed for the given command in a similar vein. For example, one of the additional total costs can be computed assuming the seek that is performed enables execution of the command after three complete revolutions of the storage disk have occurred and before a fourth complete revolution of the storage disk has occurred, another of the additional total costs can be computed assuming the seek that is performed enables execution of the command after four complete revolutions of the storage disk have occurred and before a fifth complete revolution of the storage disk has occurred, and so on. One such embodiment is described below in conjunction with FIG. 6.

Extending the seek time associated with a command as described above may allow the drive to reduce the energy cost of the seek. For example, the total energy required to complete a particular seek can vary depending on the nature of the acceleration at the beginning of the seek and the nature of the deceleration at the end of the seek. Thus, when a particular seek is performed with a relatively low magnitude and/or short duration acceleration and deceleration, the total energy expended to perform the seek can be significantly less than when the particular seek is performed with a relatively higher magnitude and/or longer duration acceleration and deceleration. Furthermore, extending the seek time associated with a command may also reduce the average power dissipation of the command by extending the command over a longer time, for example by dividing the energy expended over a longer time interval. In some embodiments, reducing the energy cost of a seek and/or reducing the average power dissipation of the command in this way may reduce the total cost of a command, even though the time cost for the command is increased.

FIG. 6 sets forth a flowchart of method steps for scheduling execution of commands in a disk drive, according to various embodiments. The method steps may include one or more operations, functions, or actions as illustrated by one or more of blocks 601-630. Although the blocks are illustrated in a sequential order, these blocks may be performed in parallel, and/or in a different order than those described herein. Also, the various blocks may be combined into fewer blocks, divided into additional blocks, and/or eliminated based upon a specific implementation. Although the method steps are described in conjunction with HDD 100 of FIGS. 1-5, persons skilled in the art will understand that the method steps may be performed with other types of systems. The control algorithms for the method steps may reside in microprocessor-based controller 133, some other controller associated with HDD 100, servo controller 315, command scheduler 317, or a combination thereof. The control algorithms can be implemented in whole or in part as software- or firmware-implemented logic, and/or as hardware-implemented logic circuits.

Prior to the method steps, HDD 100 begins operation, receives one or more commands, and stores the one or more commands in command queue 316. Generally, this process continues simultaneously with method 600. Thus, a method 600 is typically performed while HDD 100 is receiving commands and storing them in command queue 316.

Method 600 begins at step 601, when a suitable controller (e.g., microprocessor-based controller 133, servo controller 315, and/or command scheduler 317) determines whether there are one or more commands stored in command queue 316 for which no total cost has been computed. If no, method 600 returns to step 630; if yes, method 600 proceeds to step 602. In step 602, the controller selects a command from command queue 316 for which no total cost has been determined.

In step 603, the controller selects the next total cost to be computed for the selected command from the multiple total costs that are computed for the selected command. For example, in embodiments in which three total costs are calculated for each selected command, each of the three total costs is computed for a different number of additional complete revolutions (e.g., 0, 1, or 2) of storage disk 110 that occur during the seek that positions read/write head 127 at a radial location on recording surface 112 so that execution of the selected command can begin. Here, one additional revolution means that a seek time for the command is extended beyond the shortest possible seek time by a revolution, which may permit the drive to accomplish that seek using less energy. Further, each of these total costs is computed in a different iteration of steps 603-606. Therefore, in one iteration of step 603, the controller selects a total cost to be computed for the selected command when 0 complete revolutions of storage disk 110 occur during the seek that positions read/write head 127 at a radial location on recording surface 112 so that execution of the selected command can begin; in another iteration of step 603, the controller selects a total cost to be computed for the selected command when 1 complete revolution of storage disk 110 occurs during the seek that positions read/write head 127 so that execution of the selected command can begin; and, in another iteration of step 603, the controller selects a total cost to be computed for the selected command when 2 complete revolutions of storage disk 110 occur during the seek that positions read/write head 127 so that execution of the selected command can begin. Thus, in one iteration of steps 604-606, the controller assumes a seek is employed that enables execution of the selected command before a single complete revolution of storage disk 110 takes place; in another iteration of steps 604-606, the controller assumes a seek is employed that enables execution of the selected command before a second complete revolution and after a first complete revolution of storage disk 110 takes place; and in another iteration of steps 604-606, the controller assumes a seek is employed that enables execution of the selected command before a third complete revolution and after a second complete revolution of storage disk 110 takes place.

It is noted that in some instances, a seek length for the given command may be too great for a seek to be performed that enables execution of the selected command before a single complete revolution of storage disk 110 has occurred. In such instances, a total cost is not considered for the selected command based on a number of complete revolutions selected to be 0.

In step 604, the controller determines an execution time for the total cost to be computed that was selected in step 603. Step 604 can be substantially consistent with step 503 of FIG. 5. It is noted that the execution time determined in step 604 is dependent on a specific number of complete revolutions associated with the total cost to be computed that was selected in step 603. Further, because execution time is typically a weighted factor included in the cost function for determining a total cost for the selected command, the total cost determined below in step 606 can be significantly affected by the specific number of complete revolutions associated with the total cost to be computed that was selected in step 603.

In step 605, the controller determines an energy cost associated with the total cost to be computed that was selected in step 603. Step 605 can be substantially consistent with step 504 of FIG. 5. It is noted that the energy cost determined in step 605 is dependent on a specific number of complete revolutions associated with the total cost to be computed that was selected in step 603. This is the case because either: much lower accelerations (and therefore current draw) are needed to seek to a particular radial location when additional revolutions of storage disk 110 can occur before execution of the selected command begins, or similar accelerations may be applied for a much shorter time to seek to that particular radial location when additional revolutions of storage disk 110 can occur before execution of the selected command begins. Therefore, the total cost for the selected command (determined below in step 606) can be significantly affected by the specific number of complete revolutions associated with the total cost to be computed that was selected in step 603.

In step 606, the controller determines a value for the total cost to be computed that was selected in step 603. For example, in some embodiments, the controller determines the total cost via a cost function that can include multiple factors. Step 606 can be substantially consistent with step 505 of FIG. 5. As noted above, with each iteration of steps 602-609, a different total cost is determined for the same command stored in command queue 316.

In step 607, the controller determines whether the total cost selected in step 603 for the selected command (and computed in step 606) is less than the total cost of a lowest cost command currently stored in command queue 316. If no, method 600 proceeds to step 609; if yes, method 600 proceeds to step 608. In step 608, the controller updates the selected command to be the lowest cost command when using the number of complete revolutions of storage disk 110 selected in step 603.

In step 609, the controller determines whether there are remaining total costs to be computed for the selected command. If yes, method 600 returns to step 603; if no, method 600 proceeds to step 610.

In step 610, the controller determines whether HDD 100 is currently executing a command from command queue 316. If yes, method 600 returns to step 601; if no, method 600 proceeds to step 611.

In step 611, the controller selects for execution the lowest cost command currently stored in command queue 316. The controller then begins seeking read/write head 127 to the appropriate radial location on storage disk 110 so that execution of the lowest cost command can begin. In step 612, the controller updates the current value of average consumed power P̅ to include the lowest cost command.

In optional step 620, the controller determines new total costs for previously selected commands for which a total cost has been determined. In such embodiments, the updated value of average consumed power P̅ is employed when determining the new total costs for the previously selected commands. Method 600 then proceeds to step 601.

In step 630, the controller determines whether HDD 100 is currently executing a command from command queue 316. If yes, method 600 returns to step 601; if no, method 600 proceeds to step 609.

While the foregoing is directed to embodiments of the present invention, other and further embodiments of the invention may be devised without departing from the basic scope thereof, and the scope thereof is determined by the claims that follow.

We claim:

1. A method for performing disk access operations in a disk drive, the method comprising:
storing commands to perform disk access operations in a command queue for the disk drive;
determining a first total cost for performing a first command stored in the command queue, wherein the first total cost is based on at least a first energy cost associated with starting execution of the first command;
determining a second total cost for performing a second command stored in the command queue, wherein the second total cost is based on at least a second energy cost for the second command; and
in response to determining that the first total cost is less than the second total cost, selecting the first command to be the next command stored in the command queue that is to be performed by the disk drive.

2. The method of claim 1, wherein the first total cost is based at least in part on an average power consumption of the HDD over a recent time period.

3. The method of claim 2, wherein the recent time period includes a time interval in which a third command in the command queue is performed by the disk drive, wherein the third command is performed by the disk drive immediately prior to the first command.

4. The method of claim 2, wherein the average power consumption of the HDD comprises a weighted average of a plurality of consumed power values associated with executing a group of commands prior to determining the first total cost.

5. The method of claim 4, wherein the weighted average of the plurality of consumed power values comprises an exponential weighting of the plurality of consumed power values.

6. The method of claim 4, wherein each consumed power value in the plurality of consumed power values is associated with a different disk access operation or a different subinterval of an averaging time interval.

7. The method of claim 2, wherein determining the first total cost comprises computing the first total cost with a cost function that includes the first energy cost as a factor.

8. The method of claim 7, wherein a weighting in the cost function of the first energy cost varies based on the average power consumption of the HDD.

9. The method of claim 8, wherein the weighting in the cost function of the first energy cost varies proportional to the average power consumption of the HDD.

10. The method of claim 1, wherein determining the first total cost for performing the first command is performed while the disk drive is performing a third command stored in the command queue.

11. The method of claim 10, further comprising performing the first command immediately after the third command is performed.

12. The method of claim 1, wherein the first total cost is further based on an estimated time to begin the first command and the second total cost is further based on an estimated time to begin the second command.

13. The method of claim 1, wherein the first total cost is further based on a priority value associated with the first command.

14. The method of claim 13, wherein the priority value indicates a priority level of the first command.

15. The method of claim 13, wherein the priority value is based on a maximum allowable time for execution of the first command to begin.

16. The method of claim 1, further comprising determining a third total cost for performing the first command, wherein the third total cost is based on a third energy cost associated with starting execution of the first command.

17. The method of claim 16, wherein the first total cost for performing the first command is based on a seek that enables execution of the first command before a complete revolution of a storage disk of the disk drive has occurred, and the third total cost for performing the first command is based on a seek that enables execution of the first command after the complete revolution of the storage disk has occurred and before a second complete revolution of the storage disk has occurred.

18. The method of claim 1, wherein the energy cost associated with starting execution of the command from the command queue comprises energy consumed during a seek of a read/write head of the disk drive to a radial position that is associated with a starting location of the command.

19. The method of claim 1, wherein the first total cost is determined to be less than the second total cost when the first energy cost is less than the second energy cost.

20. The method of claim 1, wherein the first total cost is determined to be less than the second total cost when the first energy cost is greater than the second energy cost.

21. The method of claim 1, wherein the first total cost is further based on a third energy cost for executing a read or write operation associated with the first command, and the second total cost is further based on a fourth energy cost for executing a read or write operation associated with the second command.

22. A disk drive, comprising:
a disk with one or more recording surfaces; and
a controller configured to perform the steps of:
storing commands to perform disk access operations in a command queue for the disk drive;
determining a first total cost for performing a first command stored in the command queue, wherein the first total cost is based on at least a first energy cost associated with starting execution of the first command;
determining a second total cost for performing a second command stored in the command queue, wherein the second total cost is based on at least a second energy cost for the second command; and
in response to determining that the first total cost is less than the second total cost, selecting the first command to be the next command stored in the command queue that is to be performed by the disk drive.
